(19) United States
(12) Patent Application Publication
(10) Pub. No.: US 2023/0020354 A1
(43) Pub. Date: Jan. 19, 2023

(54) THERMAL MANAGEMENT METHOD, DEVICE, SYSTEM, AND COMPUTER-READABLE STORAGE MEDIUM

(71) Applicant: SHENZHEN ENVICOOL TECHNOLOGY CO., LTD., Shenzhen Guangdong (CN)

(72) Inventors: Shuifu YANG, Shenzhen Guangdong (CN); Wenzhen HUANG, Shenzhen Guangdong (CN); Tianfu HUANG, Shenzhen Guangdong (CN)

(73) Assignee: SHENZHEN ENVICOOL TECHNOLOGY CO., LTD., Shenzhen Guangdong (CN)

(21) Appl. No.: 17/739,144

(22) Filed: May 8, 2022

(30) Foreign Application Priority Data
Jun. 30, 2021 (CN) 202110741949.7

(51) Int. Cl. H01M 10/63; G05B 15/02; H01M 10/613; H01M 10/6567; H01M 10/48

(52) U.S. Cl. CPC H01M 10/63; G05B 15/02; H01M 10/613; H01M 10/6567; H01M 10/486

(57) ABSTRACT

A thermal management method is disclosed in the present application, which is used in a thermal management system. The thermal management system includes a battery equipment and a water chiller. The method includes: collecting a status date of the battery equipment and a real-time operation date of the water chiller; determining whether the status date is within a preset range; if the status date is not within the preset range, adjusting an operation mode of the water chiller according to the status date and the real-time operation date, so that the water chiller performs thermal management on the battery equipment according to the adjusted operation mode. The thermal management method can perform safer and more efficient thermal management control to the battery equipment. A thermal management device, a system and a computer-readable storage medium are further provided according to the present application.

### CROSS REFERENCE TO RELATED DISCLOSURES

The present disclosure claims the priority to Chinese Patent Disclosure No. 202110741949.7 titled “THERMAL MANAGEMENT METHOD, DEVICE, SYSTEM, AND COMPUTER-READABLE STORAGE MEDIUM”, filed with the China National Intellectual Property Administration on Jun. 30, 2021, which is incorporated herein by reference in its entirety.

### FIELD

The present disclosure relates to the technical field of system control, in particular to a thermal management method, and to a thermal management device, a thermal management system and a thermal management computer-readable storage medium.

### BACKGROUND

An air-cooled forced-convection heat dissipation method is mainly applied by the existing energy storage battery thermal management method, which is difficult to cool an interior of a battery pack and is difficult to evenly disperse the wind, so a certain dead zone is present. In a case that a surface temperature of the battery is too high, an internal temperature of the battery has generally exceeded an upper limit of an allowable temperature. It can be seen that the existing thermal management method lacks effective means for essentially delaying runaway and striving for processing time. For example, in an energy storage system, battery state of health (SOH) can be detected in advance through electric and thermal parameters of the battery. However, even if the existing thermal management system can detect and find that the battery state of health is in low level, there is no effective processing method and the cooling capacity cannot be output with pertinence in real time, which may easily lead to thermal runaway of the battery and cause great economic losses.

Therefore, how to make the thermal management control process for the battery equipment more efficient and safe is an urgent technical problem to be solved for those skilled in the art.

### SUMMARY

An object according to the present disclosure is to provide a thermal management method, which can perform safer and more efficient thermal management control to a battery equipment. Another object according to the present disclosure is to provide a thermal management device, a thermal management system and a computer-readable storage medium, all of which have the above beneficial effects.

In a first aspect, a thermal management method is provided according to the present disclosure, which is used in a thermal management system, the thermal management system includes a battery equipment and a water chiller, and the thermal management method includes:

collecting a status date of the battery equipment and a real-time operation date of the water chiller;

determining whether the status date is within a preset range;

if the status date is not within the preset range, adjusting an operation mode of the water chiller according to the status date and the real-time operation date, so that the water chiller performs thermal management on the battery equipment according to the adjusted operation mode. Preferably, the step of adjusting an operation mode of the water chiller according to the status date and the real-time operation date includes:

adjusting operation modes of functional members in the water chiller according to the status date and the real-time operation date,

where the functional members include a water circulation system, a mechanical refrigeration system, a dry cooler and a second refrigeration system; the water circulation system is connected to the mechanical refrigeration system by a heat exchanger, is connected in parallel with the dry cooler and is connected in series with the second refrigeration system.

In an embodiment, the state data includes one or more of ambient temperature, coolant temperature, battery temperature, battery heating power and battery state of health.

In an embodiment, the adjusting operation modes of functional members in the water chiller according to the status date and the real-time operation date includes at least one of the following cases:

in a case that the battery temperature is within a first preset range, controlling the mechanical refrigeration system to switch off, and controlling the water circulation system to switch on a cooling function;

in a case that the battery temperature is lower than the first preset range, controlling the mechanical refrigeration system to switch off, and controlling the water circulation system to switch on a heating function;

in a case that the battery temperature is higher than the first preset range, controlling the mechanical refrigeration system to switch on, and controlling the water circulation system to switch on the cooling function.

In an embodiment, the step of adjusting operation modes of functional members in the water chiller according to the status date and the real-time operation date includes at least one of the following cases:

in a case that the ambient temperature is lower than a first threshold, the battery temperature is higher than a second threshold, and the battery heating power is lower than a third threshold or the coolant temperature is lower than a fourth threshold, controlling the mechanical refrigeration system to switch off, controlling the water circulation system to switch on a cooling function, and controlling the dry cooler to switch on;

in a case that the ambient temperature is lower than the first threshold, the battery temperature is higher than the second threshold, and the battery heating power is higher than the third threshold or the coolant temperature is higher than the fourth threshold, controlling the mechanical refrigeration system and the second refrigeration system to switch on, and controlling the water circulation system to switch on the cooling function.

In an embodiment, the thermal management method further includes:

obtaining temperature dates of the functional members in the water chiller;

adjusting operation modes of an external fan and a heater band according to the temperature dates.

In an embodiment, the adjusting operation modes of an external fan and a heater band according to the temperature dates includes at least one of the following cases:

in a case that a condenser temperature is higher than a fifth threshold, controlling the external fan to operate at a scale load;

in a case that the condenser temperature is lower than the fifth threshold and an electric control box temperature is higher than a sixth threshold, controlling the external fan to operate at a maximum load;

in a case that a compressor is switched off and the ambient temperature is lower than a seventh threshold, controlling the heater band to switch on;

in a case that the compressor is switched on or the ambient temperature is higher than the seventh threshold, controlling the heater band to switch off.

In an embodiment, the thermal management method further includes:

obtaining a pressure value of a water inlet pipeline and a water return pipeline;

in a case that the pressure value exceeds a preset pressure value, outputting an alarm prompt.

In an embodiment, the thermal management method further includes:

in a case that a thermal runaway signal is received, controlling an in-box fire-fighting valve of the battery equipment to switch on, so that the battery equipment is immersed in a low-temperature coolant.

In an embodiment, the thermal management method further includes:

in a case that the status date is within the preset range, controlling the water chiller to operate according to the real-time operation date.

In a second aspect, a thermal management device is provided according to the present disclosure, which is used in a thermal management system, the thermal management system includes a battery equipment and a water chiller, and the thermal management device includes:

a collection module, which is configured to collect a status date of the battery equipment and a real-time operation date of the water chiller;

a determination module, which is configured to determine whether the status date is within a preset range;

an adjustment module, which is configured to adjust an operation mode of the water chiller according to the status date and the real-time operation date if the status date is not within the preset range, so that the water chiller performs thermal management on the battery equipment according to the adjusted operation mode.

In a third aspect, a thermal management system is provided according to the present disclosure, which includes:

a memory, which is configured to store a computer program;

a processor, which is configured to perform the thermal management method according to any one of the above when executing the computer program.

In a fourth aspect, a computer-readable storage medium storing a computer program is provided according to the present disclosure, and the computer program, when executed by a processor, causes the processor to perform the thermal management method according to any one of the above.

The thermal management method provided according to the present disclosure is used in the thermal management system which includes the battery equipment and the water chiller, and the thermal management method includes: collecting the status date of the battery equipment and the real-time operation date of the water chiller; determining whether the status date is within the preset range; if the status date is not within the preset range, adjusting the operation mode of the water chiller according to the status date and the real-time operation date, so that the water chiller performs thermal management to the battery equipment according to the adjusted operation mode.

It can be seen that the thermal management method provided according to the present disclosure can adjust the operation mode of the water chiller in combination with the real-time operation data of the water chiller in the case that the state data of the battery equipment exceeds the present range, so that the water chiller can perform thermal management control to the battery equipment according to the operation mode, which can effectively reduce the probability of low battery state of health or thermal runaway. It can be seen that, compared with the existing air-cooled forced-convection heat dissipation method, this method realizes safer and more effective thermal management control to the battery equipment.

The thermal management device, the system and the computer-readable storage medium are provided according to the present disclosure, all of which have the above beneficial effects and will not be repeated herein.

### BRIEF DESCRIPTION OF THE DRAWINGS

In order to describe technical solutions of embodiments in the present application and in the conventional technology more clearly, drawings required in the embodiments of the present application are introduced simply as follows. Certainly, the following description for drawings of the embodiments are only partial embodiments of the present application, and those skilled in the art can obtain other drawings in accordance with the provided drawings without any creative work, the other drawings obtained are also fall into the scope of protection of the present application.

FIG. 1 is a schematic flowchart of a thermal management method provided according to the present disclosure;

FIG. 2 is a schematic view of mechanisms of a water chiller provided according to the present disclosure;

FIG. 3 is a schematic structural view of a thermal management device provided according to the present disclosure; and

FIG. 4 is a schematic structural view of a thermal management system provided according to the present disclosure.

### DETAILED DESCRIPTION OF THE EMBODIMENTS

The core according to the present application is to provide a thermal management method, which can perform safer and more efficient thermal management control to a battery equipment; another core according to the present disclosure is to provide a thermal management device, a system and a computer-readable storage medium, all of which have the above beneficial effects.

In order to describe technical solutions of embodiments in the present application and in the conventional technology more clearly and completely, the technical solutions in the embodiments of the present application are introduced below with reference to the accompanying drawings in the embodiments of the present application. Certainly, the following descriptions for the embodiments are only partial embodiments of the present application, and not all of the embodiments. Based on the embodiments in the present application, all other embodiments obtained by those skilled in the art without any creative work also fall into the scope of protection of the present application.

A thermal management method is provided according to an embodiment of the present disclosure.

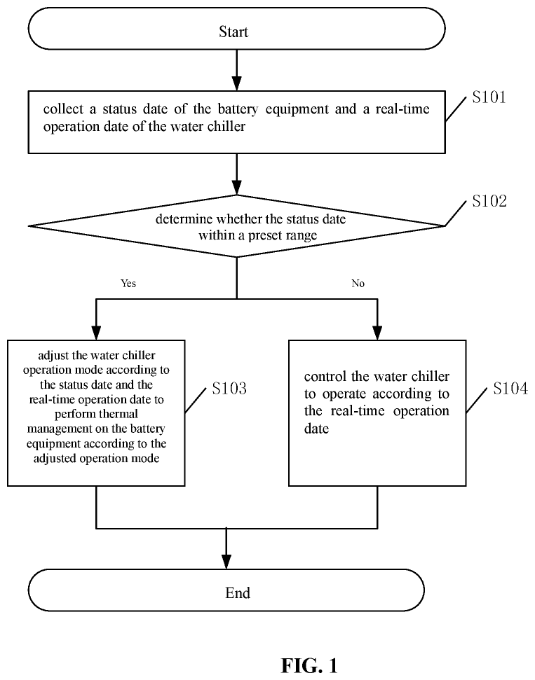

Referring to FIG. 1, which is a schematic flowchart of a thermal management method provided according to the present disclosure, the thermal management method is applied in a thermal management system, which includes a battery equipment and a water chiller, and the thermal management method includes:

S101: collecting a status date of the battery equipment and a real-time operation date of the water chiller.

The thermal management method provided according to the present disclosure is used in the thermal management system, the thermal management system includes the battery equipment and the water chiller, the battery equipment is a target equipment to be thermally managed, and the water chiller is configured to realize the thermal management to the battery equipment.

This step aims to collect date information, which can specifically include the status date of the battery equipment and the real-time operation date of the water chiller, so that the thermal management to the battery equipment is realized by using the status date and the real-time operation date. Herein, the state data of the battery equipment refers to various types of parameter information generated during the operation of the battery equipment, and the specific content thereof can be set and collected according to actual needs. For example, in an implementation, the above status date may include one or more of ambient temperature, coolant temperature, battery temperature, battery heating power and battery state of health. The real-time operation date of the water chiller refers to various types of parameter information generated during the operation of the water chiller, and the specific content thereof can also be set and collected according to actual needs. For example, the real-time operation date may be real-time operation parameters of functional members in the water chiller, which includes but not limited to a water temperature of a water pump, a rotational speed of an external fan, and a temperature of a cold storage tank.

It can be understood that the above date information can be collected in real time, so as to facilitate of performing thermal management control to the battery equipment, and further ensure the normal operation of the battery equipment.

S102: determining whether the status date is within a preset range; if the status date is not within the preset range, executing S103, if the status date is within the preset range, executing S104.

This step aims to determine abnormality of the status date, that is, to determine whether the state data is within the preset range, and the preset range can be standard date range for the normal operation of the battery equipment. In other words, in a case that the state data is within the preset range, it means that the battery equipment is currently in a normal operation state, and there is no need to adjust the water chiller for thermal management control to the battery equipment; and in a case that the state data is not within the preset range, it means that the battery equipment is currently in an abnormal operation state, and the water chiller needs to be adjusted to perform thermal management control to the battery equipment.

S103: adjusting an operation mode of the water chiller according to the status date and the real-time operation date, so that the water chiller performs thermal management to the battery equipment according to the adjusted operation mode.

In the case that the state data is not within the preset range, the water chiller needs to be adjusted to perform thermal management control to the battery equipment. Specifically, the status date of the battery equipment can be combined with the real-time operation date of the water chiller to determine the operation mode of the water chiller, and control the water chiller to operate according to the operation mode, so as to realize the thermal management control to the battery equipment.

As an embodiment, the adjusting an operation mode of the water chiller according to the status date and the real-time operation date includes: adjusting operation modes of functional members in the water chiller according to the status date and the real-time operation date; where the functional members include a water circulation system, a mechanical refrigeration system, a dry cooler and a second refrigeration system; the water circulation system is connected to the mechanical refrigeration system by a plate heat exchanger, is connected with the dry cooler in parallel and is connected with the second refrigeration system in series.

Specifically, controlling the water chiller to operate according to the adjusted operation mode is specifically configured to adjust and control operation parameters of the functional members in the water chiller, so that the status date of the battery equipment is restored to be within the preset range.

It can be understood that the specific type of the above functional members is merely one implementation provided by the embodiment, and is not unique. Other functional members can be added or removed according to actual needs, which is not limited herein.

Herein, the water circulation system can include a water inlet pipeline, a water pump, a buffer water tank, a water outlet pipeline, a water supplement pipeline and various sensors (such as a pressure sensor, a water temperature sensor, etc.) which are connected in sequence, the water inlet pipeline is connected to a water return pipeline of an energy storage system, the water outlet pipeline is connected to a water supply pipeline of the energy storage system, and a circulating working medium in the water circulation system may be water or other refrigerants. The mechanical refrigeration system may include a compressor, a condenser, an electronic expansion valve, a condensing fan, a plate heat exchanger, an electronic control module, and the like. Furthermore, the water circulation system and the mechanical refrigeration system are arranged on two sides of a cabinet of the water chiller, respectively, and are connected by the heat exchanger for heat exchange. The heat exchanger may specifically be a plate heat exchanger or a shell-tube heat exchanger.

As an embodiment, the adjusting operation modes of functional members in the water chiller according to the status date and the real-time operation date may include: in a case that the battery temperature is within a first preset range, controlling the mechanical refrigeration system to switch off, and controlling the water circulation system to switch on a cooling function; in a case that the battery temperature is lower than the first preset range, controlling the mechanical refrigeration system to switch off, and controlling the water circulation system to switch on a heating function; in a case that the battery temperature is higher than the first preset range, controlling the mechanical refrigeration system to switch on, and controlling the water circulation system to switch on the cooling function. It can be understood that, in other optional embodiments, the adjusting operation modes of functional members in the water chiller according to the status date and the real-time operation date may include at least one of the above cases.

As another embodiment, the adjusting operation modes of functional members in the water chiller according to the status date and the real-time operation date may include: in a case that the ambient temperature is lower than a first threshold, the battery temperature is higher than a second threshold, and the battery heating power is lower than a third threshold or the coolant temperature is lower than a fourth threshold, controlling the mechanical refrigeration system to switch off, controlling the water circulation system to switch on a cooling function, and controlling the dry cooler to switch on; in a case that the ambient temperature is lower than the first threshold, the battery temperature is higher than the second threshold, and the battery heating power is higher than the third threshold or the coolant temperature is higher than the fourth threshold, controlling the mechanical refrigeration system and the second refrigeration system to switch on, and controlling the water circulation system to switch on the cooling function. It can be understood that in other optional embodiments, the adjusting operation modes of functional members in the water chiller according to the status date and the real-time operation date may include at least one of the above cases.

As described above, two different realization methods for adjusting the operation modes of functional members in the water chiller are provided by the above two embodiments, which specifically are to adjust the operation modes of the functional members in the water chiller in combination with the status date of the battery equipment and the real-time operation date of the water chiller, such as switch-on and switch-off to the functional members, and specific working modes of the functional members. It should be noted that the specific values of the above thresholds and the related thresholds hereinafter do not affect the implementation of the technical solutions, and can be set by technicians in combination with the actual performance and the actual needs of the system or the equipment, which is not limited herein.

S104: controlling the water chiller to operate according to the real-time operation date.

In the case that the status date is within the preset range, there is no need to adjust the water chiller for thermal management control to the battery equipment, and at this time, the water chiller is controlled to operate according to the real-time operation date.

It can be seen that the thermal management method provided according to the present disclosure can adjust the operation modes of the water chiller in combination with the real-time operation date of the water chiller in the case that the status date of the battery equipment exceeds the preset range, so that the water chiller can perform thermal management control to the battery equipment according to the operation modes, which can effectively reduce the probability of low battery state of health or thermal runaway. It can be seen that, compared with the existing air-cooled forced-convection heat dissipation method, this method realizes safer and more effective thermal management control to the battery equipment.

Based on the above embodiments, the following embodiments are provided.

As an embodiment, the thermal management method may further include: obtaining temperature dates of the functional members in the water chiller; adjusting operation modes of an external fan and a heater band according to the temperature dates.

In order to effectively ensure the safe operation of the thermal system, the temperature of the functional members in the water chiller can be monitored, and thus the thermal management control to the functional members in the water chiller is realized by adjusting the operation modes of the external fan and the heater band, so as to effectively avoid the problem of abnormality of the water chiller caused by too high or too low temperature of the functional members. Specifically, first, the temperature dates of the functional members in the water chiller are obtained, and then operation modes of the external fan and the heater band are adjusted according to the temperature dates. The specific adjustments include but are not limited to state adjustment (switch on or switch off), operation parameter adjustment, etc., for example, in a case that the temperature of the functional member is too low, the heater band is controlled to switch on and the external fan is controlled to switch off; in a case that the temperature of the functional member is too high, the heater band is controlled to switch off and the external fan is controlled to switch on.

Herein, the adjusting operation modes of an external fan and a heater band according to the temperature dates may include: in a case that a condenser temperature is higher than a fifth threshold, controlling the external fan to operate at a scale load; in a case that the condenser temperature is lower than the fifth threshold and an electric control box temperature is higher than a sixth threshold, controlling the external fan to operate at a maximum load; in a case that a compressor is switched off and the ambient temperature is lower than a seventh threshold, controlling the heater band to switch on; in a case that the compressor is switched on or the ambient temperature is higher than the seventh threshold, controlling the heater band to switch off. It should be understood that in other optional embodiments, adjusting the operation modes of an external fan and a heater band according to the temperature dates may specifically include at least one of the above cases.

Similar to the adjustment method to the functional members in the water chiller, the operation modes of the external fan and the heater band can be adjusted according to the temperature dates of the functional members in the water chiller, such as switch-on and switch-off of the external fan and the heater band and the specific operation modes in switch-on state of the external fan and the heater band. Herein, the condenser and the electric control box and the compressor all belong to the functional members in the mechanical refrigeration system.

It can be understood that the above steps can be performed in real time in the process of thermal management, and the external fan and the heater band are controlled in real time by monitoring the temperature dates of the functional members in the water chiller in real time, so as to effectively avoid the abnormality of the functional members and further ensure the safe operation of the thermal system.

As another embodiment, the thermal management method may further include: obtaining pressure values of a water inlet pipeline and a water return pipeline; in a case that the pressure values exceeds a preset pressure value, outputting an alarm prompt.

It can be understood that the water circulation system heat or cool the battery equipment by means of a water pump, that is, the thermal management control to the battery equipment is realized by heating or cooling the water (or other types of liquids) in the water pipe. Therefore, the pressure values of the liquid in the water inlet pipeline and the water return pipeline inevitably have an impact on the operation of the thermal management system. On this basis, the pressure values of the water inlet pipeline and the water return pipeline can be monitored in real time. Once the monitored pressure values exceed the preset pressure value, an alarm prompt is output to remind the staff to repair the pipeline in time and avoid abnormality of operation of the thermal management system. The alarm mode may include but not limited to sound alarm, light alarm, vibration alarm, etc., which is not limited herein.

As another embodiment, the thermal management method may further include: in a case that a thermal runaway signal is received, controlling an in-box fire-fighting valve of the battery equipment to switch on, so that the battery equipment is immersed in a low-temperature coolant.

In order to further ensure the safe operation of the thermal management system, the battery equipment can be monitored in real time. In the case that a thermal runaway signal is monitored, it means that the current state of health of the battery equipment is in low level, and thus it is impossible for conducting the thermal management control to the battery equipment still by the water chiller. Therefore, the in-box fire-fighting valve of the battery equipment can be directly switched on, so that the low-temperature coolant enters and immerses the battery equipment to realize a heavy cooling of the battery equipment.

Herein, the low-temperature coolant can specifically be ethylene glycol, propylene glycol coolant, or fluorinated liquid with good insulating properties, or heptafluoropropane and perfluorohexanone with a performance of fire-fighting cooling and dilution of combustible gas.

In addition, the specific type of the thermal runaway signal is not unique, which can be the temperature or the temperature rise rate of the water chiller itself, or signals of an additional gas detection, pressure detection, insulation detection or Battery Management System (BMS).

Similarly, the above alarm prompt and detection of thermal runaway signal can be performed in real time in the process of thermal management, so as to effectively avoid faults and ensure the safe operation of the thermal system.

Based on the above embodiments, another thermal management method is provided according to embodiments of the present disclosure, and the specific implementation process is as follows.

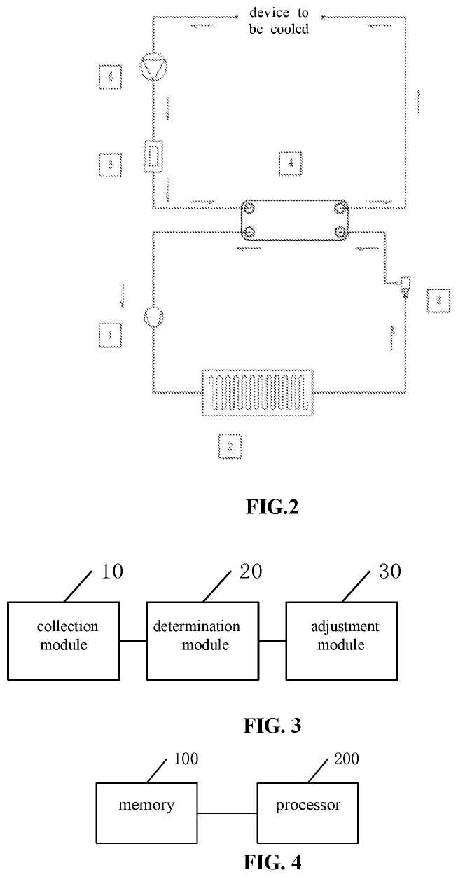

The thermal management method provided according to the present disclosure is applied in a thermal management system, the thermal management system includes a water chiller and a battery equipment, and the water chiller is configured to realize thermal management control to the battery equipment. Referring to FIG. 2, which is a schematic view of mechanisms of the water chiller provided according to the present disclosure, the reference numerals are as follows: 1—inverter compressor, 2—condenser, 3—electronic expansion valve, 4—plate heat exchanger, 5—heating electric pipe and 6—internal circulating water pump.

Specifically, the water chiller includes a cabinet with a mechanical refrigeration system and a water circulation system inside, the mechanical refrigeration system and the water circulation system are arranged on two sides of the cabinet, respectively, and are connected by the heat exchanger for heat exchange. The heat exchanger may specifically be a plate heat exchanger or a shell-tube heat exchanger. Herein, the water circulation system may include a water inlet pipeline, a water pump, a buffer water tank, a water outlet pipeline, a water supplement pipeline and various sensors (such as a pressure sensor, a water temperature sensor, etc.) which are connected in sequence, the water inlet pipeline is connected to a water return pipeline of an energy storage system, the water outlet pipeline is connected to a water supply pipeline of the energy storage system, and a circulating working medium in the water circulation system may be water or other refrigerants. The mechanical refrigeration system includes a compressor, a condenser, an electronic expansion valve 3, a condensing fan, a plate heat exchanger and an electronic control module.

Based on the thermal management control to the battery equipment realized by the above thermal management system, the corresponding achievable solutions are as follows.

First Solution

(1) obtaining an ambient temperature, a battery temperature and a cooling water temperature;

(2) in a case that the battery temperature ranges from 5 to 25° C. or the cooling water temperature ranges from 10 to 15° C., there is no need for heating or refrigeration, the mechanical refrigeration system stops and the water pump continues to operate, in order to realize self-circulating cooling;

(3) in a case that the ambient temperature is less than or equal to 15° C. with a heating requirement for the battery, starting an electric heating function or heat pump function;

(4) in a case that the ambient temperature is greater than 15° C., the battery temperature is greater than 30° C., and the battery generates heat with high power or the cooling water temperature is greater than or equal to 25° C., switching on the mechanical refrigeration system, switching on the water pump and the cooling fan, and performing refrigeration at a plate heat exchanger. Herein, the battery heating power can be calculated by collecting corresponding relevant parameters of the battery.

Second Solution

In order to further realize the effect of energy saving, a dry cooler may be provided so as to be connected in parallel on a water system side of the heat exchanger of the water chiller, which can make full use of the natural cold source when the external temperature is low, so as to better fit the heating characteristics of the battery. In addition, since the variation of the water temperature is moderate, it can effectively avoid the impact of rapid fluctuation of water temperature caused by strong cooling to the battery. In specific implementation:

(1) obtaining an ambient temperature, a battery temperature and a cooling water temperature;

(2) in a case that the ambient temperature is less than or equal to 15° C., the battery temperature is greater than 25° C., and the battery generates heat with high power or the cooling water temperature is less than 20° C., switching off the mechanical refrigeration system, switching on the water pump and the cooling fan, and switching on the dry cooler.

Certainly, the above solution can be realized by connecting with a fluorine pump system in parallel.

Third Solution

In order to further realize the effect of energy saving, a second refrigeration system (specifically a dry cooler or an indirect evaporative cooling unit or a second mechanical refrigeration system) can be connected in series on the water system side of the heat exchanger of the water chiller, which can make full use of natural source for heat dissipation by the combination of various refrigeration systems and thus can meet the needs of large cooling capacity. In specific implementation:

(1) obtaining an ambient temperature, a battery temperature and a cooling water temperature;

(2) in a case that the ambient temperature is less than or equal to 15° C., the battery temperature is greater than 25° C., and the battery generates heat with high power or the cooling water temperature is greater than or equal to 20° C., switching on the second refrigeration system to pre-cool the cooling water, and performing a second heat exchange at the plate heat exchanger so as to further lower the water temperature.

Fourth Solution

In order to further realize the effect of energy saving, the information such as power, temperature and pressure of the functional members in the water chiller can be collected, and then the lowest power consumption of the water chiller under a same refrigeration capacity can be achieved by adjusting the operation combination of the functional members. In specific implementation:

(1) obtaining a battery temperature, a cooling water temperature and a power;

(2) in a case that the cooling water temperature is less than or equal to 20° C., the battery temperature is less than or equal to 25° C., and the battery generates heat with low power, and COP (cooling capacity/power consumption) of the water chiller is less than 4, reducing a rotation speed of one or all functional members of the compressor, the water pump and the fan.

Fifth Solution

Based on the above solutions, detecting a heat dissipation requirement of the functional members in the water chiller in order to realize thermal management control of the functional members and ensure the safe operation of the thermal management system. In specific implementation:

(1) detecting whether the functional members in the water chiller have a thermal management requirement, the functional members include a condenser, an electric control box, a compressor, etc.;

(2) in a case that the condenser has a heat dissipation requirement, controlling an external fan to operate according to load requirement;

(3) in a case that the condenser has no heat dissipation requirement, determining whether a temperature of the electric control box reaches or is higher than a preset value (that is, determining whether the electric control box has a heat dissipation requirement), controlling the external fan to switch on and run at an upper limit speed if yes; controlling the external fan to stop running if no;

(4) in a case that the compressor is switched off and the ambient temperature is lower than −10° C., controlling the heater band to switch on; in a case that the compressor is switched on or the ambient temperature is higher than −10° C., controlling the heater band to switch off.

Sixth Solution

Based on the above solutions, a safety alarm function is realized. In a specific implementation:

detecting a pressure of a water inlet pipeline and a water return pipeline, if an apparent abnormality occurs (for example, in a case that the pressure of the water inlet pipeline or the water return pipeline is relatively high, reducing the rotation speed of the water pump to reduce the water outlet pressure; in a case that the pressure of the water inlet pipeline or the water return pipeline is excessively high, controlling a safety valve to stop the operation of the water pump), determining whether the abnormality occurs in a pipeline on the battery side (such as leakage/extrusion, etc.), and outputting a safety alarm in the case that the abnormality occurs.

Seventh Solution

Based on the above solutions, thermal management control is performed on the battery equipment by detecting the state of health of the battery equipment. In specific implementation:

(1) obtaining a status date of the battery (such as battery state of health, battery temperature, etc.);

(2) in a case that the battery state of health is relatively low, and the battery temperature is greater than T1° C., controlling the water pump to operate at an upper limit or the compressor to operate at an upper limit or the fan to operate at an upper limit so as to rapidly lower the battery temperature and then maintain the battery temperature less than T1° C.;

(3) in a case that the battery state of health is relatively low, and the battery temperature is less than or equal to T2° C., switching on a cold storage mode: first lowering a working medium temperature inside a cold storage box to be less than T1° C. by using the mechanical refrigeration system, and then making the cold storage box be connected with a battery cold plate in series for operation; [symbol] where the cold storage box can be filled with only a coolant or with PCM ( [symbol] Phase Change Materials) inside; in addition, when the battery is working healthily, the cold storage box may be connected with the battery cold plate in series, so that the battery can work at a high current-rate without the temperature rise being too high, and also reduce the refrigeration power and save energy effectively;

(4) if the battery state of health is in an extremely low level and an apparent thermal runaway signal occurs, switching on an in-box fire-fighting valve of the battery, so that a low-temperature coolant immerses the battery and strongly decreases the battery temperature;

where the thermal runaway signal can be the temperature and the temperature rise rate of water machine itself, or can be an additional gas detection, pressure detection, insulation detection, BMS signal, etc.

Eighth Solution

Based on the above solution, when the energy storage system is in a state of installation, debugging or maintenance, the battery equipment does not work. However, in a case that the system has poor wiring or other possibilities that may cause a short circuit of the battery/electrical device, the temperature of the battery is lowered below T1° C., so as to effectively reduce the risk of thermal runaway of the battery.

It can be seen that in the thermal management method provided according to the present disclosure, the operation modes of the water chiller are adjusted in combination with the real-time operation date of the water chiller in the case that the status date of the battery equipment exceeds the present range, so that water chiller can perform thermal management control to the battery equipment according to the operation modes, which can effectively reduce the probability of low battery state of health or thermal runaway. It can be seen that, compared with the existing air-cooled forced-convection heat dissipation method, this method realizes safer and more effective thermal management control to the battery equipment.

In order to solve the above technical problems, a thermal management device is provided according to the present disclosure. Referring to FIG. 3, which is a schematic structural view of the thermal management device provided according to the present disclosure, the thermal management device is applied in the thermal management system including a battery equipment and a water chiller, and the thermal management device includes:

a collection module 10, which is configured to collect a status date of the battery equipment and a real-time operation date of the water chiller;

a determination module 20, which is configured to determine whether the status date is within a preset range;

an adjustment module 30, which is configured to adjust an operation mode of the water chiller according to the status date and the real-time operation date if the status date is not within the preset range, so that the water chiller performs thermal management on the battery equipment according to the adjusted operation mode.

It can be seen that in the thermal management device provided according to the present disclosure, the operation modes of the water chiller are adjusted in combination with the real-time operation date of the water chiller in the case that the status date of the battery equipment exceeds the present range, so that water chiller can perform thermal management control to the battery equipment according to the operation modes, which can effectively reduce the probability of low battery state of health or thermal runaway. It can be seen that, compared with the existing air-cooled forced-convection heat dissipation method, this method realizes safer and more effective thermal management control to the battery equipment.

As a preferred embodiment, the above adjustment module 30 can be specifically configured to adjust operation modes of functional members in the water chiller according to the status date and the real-time operation date; the functional members include a water circulation system, a mechanical refrigeration system, a dry cooler and a second refrigeration system; the water circulation system is connected to the mechanical refrigeration system by a heat exchanger, is connected in parallel with the dry cooler and is connected in series with the second refrigeration system.

As a preferred embodiment, the above state data includes one or more of ambient temperature, coolant temperature, battery temperature, battery heating power and battery state of health.

As a preferred embodiment, the above adjustment module 30 can be specifically configured to, in a case that the battery temperature is within the first preset range, control the mechanical refrigeration system to switch off and control the water circulation system to switch on a cooling function; in a case that the battery temperature is lower than the first preset range, control the mechanical refrigeration system to switch off, and control the water circulation system to switch on a heating function; in a case that the battery temperature is higher than the first preset range, control the mechanical refrigeration system to switch on, and control the water circulation system to switch on the cooling function. It can be understood that in an optional embodiment, the above adjustment module 30 is specifically configured to perform at least one of the above cases.

As a preferred embodiment, the above adjustment module 30 can be specifically configured to, in a case that the ambient temperature is lower than a first threshold, the battery temperature is higher than a second threshold, and the battery heating power is lower than a third threshold or the coolant temperature is lower than a fourth threshold, control the mechanical refrigeration system to switch off, control the water circulation system to switch on a cooling function, and control the dry cooler to switch on; in a case that the ambient temperature is lower than the first threshold, the battery temperature is higher than the second threshold, and the battery heating power is higher than the third threshold or the coolant temperature is higher than the fourth threshold, control the mechanical refrigeration system and the second refrigeration system to switch on, and control the water circulation system to switch on the cooling function. It can be understood that in an optional embodiment, the above adjustment module 30 is specifically configured to perform at least one of the above cases.

As a preferred embodiment, the thermal management device includes:

a safety management module, which is configured to obtain temperature dates of the functional members in the water chiller; adjust operation modes of an external fan and a heater band according to the temperature dates.

As a preferred embodiment, the safety management module can be specifically configured to, in a case that a condenser temperature is higher than a fifth threshold, control the external fan to operate at a scale load; in a case that the condenser temperature is lower than the fifth threshold and an electric control box temperature is higher than a sixth threshold, control the external fan to operate at a maximum load; in a case that a compressor is switched off and the ambient temperature is lower than a seventh threshold, control the heater band to switch on; in a case that the compressor is switched on or the ambient temperature is higher than the seventh threshold, control the heater band to switch off. It can be understood that in an optional embodiment, the above safety management module can be specifically configured to perform at least one of the above cases.

As a preferred embodiment, the thermal management device includes:

an alarm prompt module, which is configured to obtain a pressure value of a water inlet pipeline and a water return pipeline; in a case that the pressure value exceeds a preset pressure value, output an alarm prompt.

As a preferred embodiment, the thermal management device includes:

a thermal runaway control module, which is configured to, in a case that a thermal runaway signal is received, controlling an in-box fire-fighting valve of the battery equipment to switch on, so that the battery equipment is immersed in a low-temperature coolant.

As a preferred embodiment, the thermal management device includes:

a control module, which is configured to, in a case that the status date is within the preset range, controlling the water chiller to operate according to the real-time operation date.

For description of the device according to the present disclosure, reference may be made to the above method embodiments, which is not repeated herein.

In order to solve the above problems, a thermal management system is provided according to the present disclosure. Referring to FIG. 4, which is a schematic structural view of the thermal management system provided according to the present disclosure, the thermal management system may include:

a memory 100, which is configured to store a computer program;

a processor 200, which is configured to perform the thermal management method according to any one of the above when executing the computer program.

For description of the system according to the present disclosure, reference may be made to the above method embodiments, which is not repeated herein.

In order to solve the above problems, a computer-readable storage medium storing a computer program is provided according to the present disclosure. The computer program, when executed by a processor, causes the processor to perform the thermal management method according to any one of the above.

The storage medium may include various medium capable to store a program code, for example, a USB flash disk, a mobile hard disk, a read-only memory (ROM), a random access memory (RAM), a diskette, or a light disk.

For description of the computer-readable storage medium according to the present disclosure, reference may be made to the above method embodiments, which is not repeated herein.

The embodiments in this specification are described in a progressive way, each of which emphasizes the differences from others, and the same or similar parts among the embodiments can be referred to each other. Since the devices disclosed in the embodiment corresponds to the method disclosed in the embodiment, the description for the device is simple, and reference may be made to the method in the embodiment for the relevant parts.

It is further understood by those skilled in the art that units and algorithm steps described in combination with the disclosed embodiments may be implemented by electronic hardware, computer software or a combination thereof. In order to clearly describe interchangeability of the hardware and the software, the units and the steps are generally described above based on functions. Whether these functions are performed in hardware or software depends on the specific application and design constraints for the technical solution. Those skilled in the art may use different methods to implement the described functions for each particular application, and such implementation should not be regarded as going beyond the scope of the present application.

Steps of the method or algorithm described in the embodiments herein may be directly implemented by hardware, a software module executed by a processor, or a combination thereof. The software module may be arranged in any storage medium known in the technical field, such as a random access memory (RAM), a memory, a read only memory (ROM), an electrically programmable ROM, an electrically erasable programmable ROM, a register, a hard disk, a removable disk, and a compact disc read-only memory (CD-ROM).

The technical solutions provided in the present application have been described in detail. The principle and the embodiments of the present application are described herein by specific examples. The description of the above embodiments is intended to facilitate understanding the method and idea of the present application. It should be noted that, various alternations and modifications may be made to the technical solutions of the present application by those skilled in the art without departing from the principle of the present application, which shall fall within the protection scope of the present application.

1. A thermal management method used in a thermal management system, the thermal management system comprises a battery equipment and a water chiller, wherein the thermal management method comprises the following steps:
collecting a status date of the battery equipment and a real-time operation date of the water chiller;
determining whether the status date is within a preset range;
if the status date is not within the preset range, adjusting an operation mode of the water chiller according to the status date and the real-time operation date, so that the water chiller performs thermal management to the battery equipment according to the adjusted operation mode.

2. The thermal management method according to claim 1, wherein the step of adjusting an operation mode of the water chiller according to the status date and the real-time operation date comprises:
adjusting operation modes of functional members in the water chiller according to the status date and the real-time operation date,
wherein the functional members comprise a water circulation system, a mechanical refrigeration system, a dry cooler and a second refrigeration system, the water circulation system is connected to the mechanical refrigeration system by a heat exchanger, is connected in parallel with the dry cooler and is connected in series with the second refrigeration system.

3. The thermal management method according to claim 2, wherein the state data comprises one or more of ambient temperature, coolant temperature, battery temperature, battery heating power and battery state of health.

4. The thermal management method according to claim 3, wherein the step of adjusting operation modes of functional members in the water chiller according to the status date and the real-time operation date comprises at least one of the following cases:
in a case that the battery temperature is within a first preset range, controlling the mechanical refrigeration system to switch off, and controlling the water circulation system to switch on a cooling function;
in a case that the battery temperature is lower than the first preset range, controlling the mechanical refrigeration system to switch off, and controlling the water circulation system to switch on a heating function;
in a case that the battery temperature is higher than the first preset range, controlling the mechanical refrigeration system to switch on, and controlling the water circulation system to switch on the cooling function.

5. The thermal management method according to claim 3, wherein the step of adjusting operation modes of functional members in the water chiller according to the status date and the real-time operation date comprises at least one of the following cases:
in a case that the ambient temperature is lower than a first threshold, the battery temperature is higher than a second threshold, and the battery heating power is lower than a third threshold or the coolant temperature is lower than a fourth threshold, controlling the mechanical refrigeration system to switch off, controlling the water circulation system to switch on a cooling function, and controlling the dry cooler to switch on;
in a case that the ambient temperature is lower than the first threshold, the battery temperature is higher than the second threshold, and the battery heating power is higher than the third threshold or the coolant temperature is higher than the fourth threshold, controlling the mechanical refrigeration system and the second refrigeration system to switch on, and controlling the water circulation system to switch on the cooling function.

6. The thermal management method according to claim 3, further comprising:
obtaining temperature dates of the functional members in the water chiller;
adjusting operation modes of an external fan and a heater band according to the temperature dates.

7. The thermal management method according to claim 6, wherein the step of adjusting operation modes of an external fan and a heater band according to the temperature dates comprises at least one of the following cases:
in a case that a condenser temperature is higher than a fifth threshold, controlling the external fan to operate at a scale load;
in a case that the condenser temperature is lower than the fifth threshold and an electric control box temperature is higher than a sixth threshold, controlling the external fan to operate at a maximum load;
in a case that a compressor is switched off and the ambient temperature is lower than a seventh threshold, controlling the heater band to switch on;
in a case that the compressor is switched on or the ambient temperature is higher than the seventh threshold, controlling the heater band to switch off.

8. The thermal management method according to claim 1, further comprising:
obtaining a pressure value of a water inlet pipeline and a water return pipeline;
in a case that the pressure value exceeds a preset pressure value, outputting an alarm prompt.

9. The thermal management method according to claim 1, further comprising:
in a case that a thermal runaway signal is received, controlling an in-box fire-fighting valve of the battery equipment to switch on, so that the battery equipment is immersed in a low-temperature coolant.

10. The thermal management method according to claim 1, further comprising:
in a case that the status date is within the preset range, controlling the water chiller to operate according to the real-time operation date.

11. A thermal management device used in a thermal management system, the thermal management system comprises a battery equipment and a water chiller, wherein the thermal management device comprises:
a collection module, which is configured to collect a status date of the battery equipment and a real-time operation date of the water chiller;
a determination module, which is configured to determine whether the status date is within a preset range;
an adjustment module, which is configured to adjust an operation mode of the water chiller according to the status date and the real-time operation date if the status date is not within the preset range, so that the water chiller performs thermal management to the battery equipment according to the adjusted operation mode.

12. A thermal management system, comprising:
a memory, which is configured to store a computer program;
a processor, which is configured to perform the thermal management method according to claim 1 when executing the computer program.

13. The thermal management system according to claim 12, wherein the step of adjusting an operation mode of the water chiller according to the status date and the real-time operation date comprises:
adjusting operation modes of functional members in the water chiller according to the status date and the real-time operation date,
wherein the functional members comprise a water circulation system, a mechanical refrigeration system, a dry cooler and a second refrigeration system, the water circulation system is connected to the mechanical refrigeration system by a heat exchanger, is connected in parallel with the dry cooler and is connected in series with the second refrigeration system.

14. The thermal management system according to claim 13, wherein the state data comprises one or more of ambient temperature, coolant temperature, battery temperature, battery heating power and battery state of health.

15. A computer-readable storage medium storing a computer program, wherein the computer program, when executed by a processor, causes the processor to perform the thermal management method according to claim 1.
